(19) United States
(12) Patent Application Publication
(10) Pub. No.: US 2026/0006463 A1
(43) Pub. Date: Jan. 1, 2026

(54) SYSTEM, METHOD AND APPARATUS FOR AUTOMATIC DETECTION AND RESOLUTION OF RADIO INTERFERENCE

(71) Applicant: Saudi Arabian Oil Company, Dhahran (SA)

(72) Inventors: Rami A. Al-Ghanim, Dhahran (SA); Abdullah Y. Al-Hassan, Dhahran (SA); Mohsen F. Al-Shammari, Khafji (SA); Firas A. Al-Kaud, Riyadh (SA)

(73) Assignee: Saudi Arabian Oil Company, Dhahran (SA)

(21) Appl. No.: 18/760,884

(22) Filed: Jul. 1, 2024

(51) Int. Cl. H04W 24/04; H04B 17/345

(52) U.S. Cl. CPC H04W 24/04; H04B 17/345

(57) ABSTRACT

A communication system for automatic detection and resolution of radio interference comprises a base station set on a primary frequency, sensors adapted to detect current parameters of the base station including interference on the primary frequency and a processor configured to generate a signal based on sensor output. A set of relays coupled to base station and includes a pooling relay is configured to switch the primary frequency to one of a pool of available secondary frequencies upon detection by the sensor of interference on the primary frequency. A centralized monitoring device processes the current parameters to determine whether the parameters indicate a defect at the base station, and sends notifications in response to the determination of the defect. An AI processor is configured to train and execute a first machine learning model that uses the parameter information and to output a classification of a cause of a defect.

### FIELD OF THE DISCLOSURE

The present disclosure relates to wireless communications, and more specifically, to solutions for detecting and resolving radio interference in a Terrestrial Trunked Radio (TETRA) system environment.

### BACKGROUND OF THE DISCLOSURE

Many large-scale organizations utilize a communication infrastructure to facilitate their operations. In many cases it is desirable for the communication technology employed to have certain specifications related to response time, range, capacity, security and encryption. Terrestrial Trunked Radio (TETRA) technology has been developed to meet such needs and provide some advantages over other technologies.

The demand for mission-critical communications has grown rapidly and has led to an enormous growth of TETRA usage due to its numerous capabilities. TETRA systems can: 1) rapidly set up calls (an essential aspect for emergencies); 2) support one-to-one, one-to-many and many-to-many calls; 3) provide emergency button features that can override any ongoing activity and disconnect low priority users; 4) secure communication calls with high level voice encryption; 5) enable Direct Mode Operation (DMO) which allows the operation of radio channels/terminals in the absence of an operating network; 6) cover a larger geographic range compared to other technologies due to the usage of a low frequency; and 7) ensure non-interrupted voice call transitions between networks.

The base stations used in TETRA networks typically transmit and receive radio waves at a certain primary frequency to provide two-way communications. The base station acts as the local wireless network hub and the gateway between wired and wireless networks. The setup of the primary frequency varies based on the location to ensure no interference that cause service interruption.

A significant drawback of TETRA networks is that a given system typically operates on singular frequency. A common behavior of TETRA radio base station is to jam traffic whenever radio frequency interreference is detected. This jamming causes service interruption and can have a detrimental effect on communication continuity.

It is with respect to these and other considerations that the present disclosure is presented.

### SUMMARY OF THE DISCLOSURE

In a first aspect, the present disclosure describes a communication system for automatic detection and resolution of radio interference (ADDRI). The system comprises a wireless communication base station including a transmitter and receiver that are set in a normal operation on a primary frequency, a plurality of sensors adapted to detect current parameters of the base station including a level of interference on a selected primary frequency received by the receiver, and a processor configured to generate a signal based on output of the sensor, and a first relay coupled to the processor. The system further includes a set of relays coupled to the first relay of the base station and including a pooling relay, wherein the pooling relay is configured to commence a process of switching the primary frequency to one of a pool of available secondary frequencies upon receipt of a command signal from the based station generated in response to detection by the sensor of interference on the primary frequency. A centralized monitoring and tracking device is coupled to base station and adapted to receive and process the current parameters output by the plurality of sensors in order to determine whether the current parameters are indicative of a defect at the base station, and to send notifications in response to the determination of the defect, An AI processor coupled to the centralized monitoring and tracking device and configured to execute a first AI module, the first AI module including executable code for training and executing a first machine learning model that uses, as input, the parameter information received form the centralized monitoring and tracking device, and outputs a classification of a cause of a defect determined by the centralized monitoring and tracking device.

In a further aspect, the present disclosure describes a method for automatic detection and resolution of radio interference (ADDRI). The method comprises detecting, at a sensor of a base station, current parameters of the base station including a level of interference on a selected primary frequency used by the base station during normal operation, sending a signal in response to interference being detected to commence a process of switching the primary frequency to one of a pool of available secondary frequencies, determining whether any of the current parameters are indicative of a defect at the base station, sending a notification in response to a defect being determined, training a first machine learning model including using the current parameters over time to determine defects in the current parameters, and executing the first machine learning model to output a classification of a cause of the defect in the current parameters of the base station.

These and other aspects, features, and advantages can be appreciated from the following description of certain embodiments and the accompanying drawing figures and claims.

### BRIEF DESCRIPTION OF THE DRAWINGS

FIG. 1 is a a schematic block diagram of a system for Automatic Detection and Resolution of Radio Interference (ADDRI) according to an embodiment of the present disclosure.

FIG. 2 is an illustration of an exemplary communication process between the CAMLNTS and the TBS using SNMP according to an implementation of the present disclosure.

FIG. 3 is a schematic diagram that shows functional elements and output of the ADDRI system according to an embodiment of the present disclosure.

FIG. 4 is a flow chart of a method of switching a frequency of communication service according to an embodiment of the present disclosure.

### DETAILED DESCRIPTION OF CERTAIN EMBODIMENTS OF THE DISCLOSURE

The present disclosure describes a system in which Terrestrial Trunked radio (TETRA) base is configured to enable selection of a healthy frequency band from a designated frequency pool whenever there is excessive traffic or interference on a particular channel. The base station is operative to shift voice/data traffic into the newly configured frequency. In addition, the system is configured to troubleshoot and recover the primary frequency. As soon as the primary frequency is restored, the base station is configured to switch back to the original setup after checking and confirming its health.

Capabilities are provided for identifying the causes, sources, and the types of radio frequency interference. This feature aids in accelerating the recovery process. Through machine learning implementations, the system provides early interference prediction. Relevant notifications can be delivered to assist operators in addressing potential radio traffic problems before they occur. For example, when the system determines that jamming is intermittent, the system can report to operators so they can take appropriate action. The system is also integrated with a disaster recovery system (DRS) such that if and when the entire frequency spectrum fails and it is unable to recover the service, a signal is sent to DRS to provide temporary radio services in the impacted areas.

In sum, by providing these services, the systems and methods disclosed herein provides the most efficient way to communicate during emergencies, ensures the continuity of radio services even when the main frequency fails, and provide early predictions of potential problems that might negatively impact the availability of radio services.

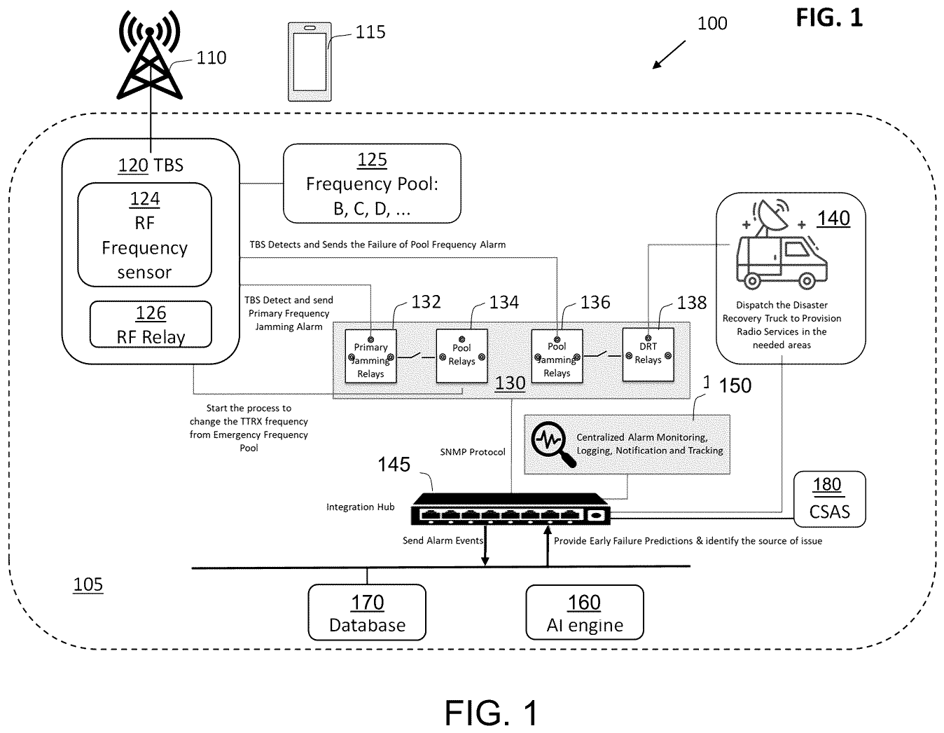

FIG. 1 is a schematic block diagram of an example system 100 for Automatic Detection and Resolution of Radio Interference (“ADDRI”) 105 can be implemented according to an embodiment of the present disclosure. In an example configuration shown in FIG. 1 and further described herein, the ADRRI system of the present disclosure is implemented within a TETRA communication system environment. TETRA is a European Telecommunications Standards Institute (ETSI) standard. Example configurations, features and functions of a TETRA communication system environment are described in more detail in the TETRA standards promulgated by ETSI (website: https://www.etsi.org/), as updated from time to time, and may be modified as desired to implement the various functions and features described herein. Although embodiments of the ADRRI solution are described herein as being implemented in a wireless network system that comprises a TETRA network, the embodiments are not so limited and can be implemented in other existing or future wireless communication networks without departing from the scope of the embodiments.

The ADDRI 105 comprises a base station (TBS) 120 that includes electronics for transmitting and receiving an RF signal with a specific frequency configuration via antenna 110 to provide a two-way communication with user equipment 115. Each TBS has a certain frequency configuration for transmission. Typically, the operating frequency of each individual TBS (e.g., TBS 120) is different from geographically neighboring TBSs (not shown) so as to minimize any interference that can cause service interruption. In the depicted embodiment, the TBS 120 includes an RF frequency sensor 124 and an RF relay 126 as internal components. In other embodiments, one or more of the RF frequency sensor and RF relay can be coupled to but housed separately from the TBS 120. The TBS 120 also includes components for providing operability as a local wireless network hub and as a gateway between wired and wireless networks. During regular operation, the TBS performs periodic frequency spectrum scans to identify whether there is any other source using the TBS reserved frequency. If a coinciding frequency is detected, this triggers the TBS to transmit a notification.

As noted, the TBS 120 communicates with user equipment over a singular frequency. Conventionally, if the RF frequency sensor 124 of the TBS detects interference at the communication frequency, it is configured to jam the frequency, causing a temporary loss of the communication capability over the frequency in question. Such loss of communication capability of course can impact operation and safety during emergencies. The RF relay 126 is coupled to a set of relays 130 for enabling alarm communications to be delivered from the TBS 120 to downstream components. The set of relays 130 includes primary jamming relays 132 that are activated in response to the TBS sensor 124 detecting inference on the primary frequency and causes a stoppage of transmission and reception on the primary frequency. The set of relays 130 further includes pooling relays 134 coupled to a plurality of secondary frequency transmitters. The pooling relays are activated by the TBS 120 to commence the process of changing the transmission frequency to one of the secondary frequencies of the frequency pool. Pooling jamming relays 136 are activated by the TBS 120 in response to the TBS detecting a failure to provide transmission on the secondary frequency. Activation of the pool jamming relays 136 activates, in turn, the disaster recovery (DRT) relays 138 which send an alarm to dispatch a disaster recovery team 140. The disaster recovery team 140 may employ a vehicle to provision radio services in regions while the TETRA system is unable to do so.

The set of relays 130 as well as the disaster recovery team 140 are communicatively coupled to an integration hub 145. The integration hub 145 can include a software integration engine that is configured to coordinate incoming and outgoing streams of information. Communications between the relay bank and integration hub can utilize the SNMP protocol (Simple Network Management Protocol). Also coupled to the integration hub 145 is a Centralized Alarm Monitoring, Logging, Notification, and Tracking System (CAMLNTS) 150. The CAMLNTS 150 can be implemented as a standalone system (e.g., not part of the TETRA network per sc) that is integrated with the TETRA network via the integration hub 145. SNMP Protocol is preferably used to exchange communications between the TETRA and CAMLNTS. The CAMLNTS 150 monitors a number of parameters received from the TBS 120 and other parts of the TETRA network. The monitored parameters include, as examples, RF signal jamming time, packet drop rates, central processing unit (CPU) utilization rate as well as TBS internal temperature. The RF signal jamming time is taken as an indicator of interference if it is above 15 minutes. High packet drop rates are associated with a high probability of cable disconnection. Similarly, high CPU utilization rates can be taken as an indicator of a potential card failure. Additionally, the CAMLNTS 150 receives notifications transmitted by the TBS, for instance, when the TBS 120 detects (that is, in response to the detection of) interference on its reserved frequency. The ADRRI system 105 can further be in communication with one or more external systems such as a Communication Supervisory Alarm System (CSAS) 180.

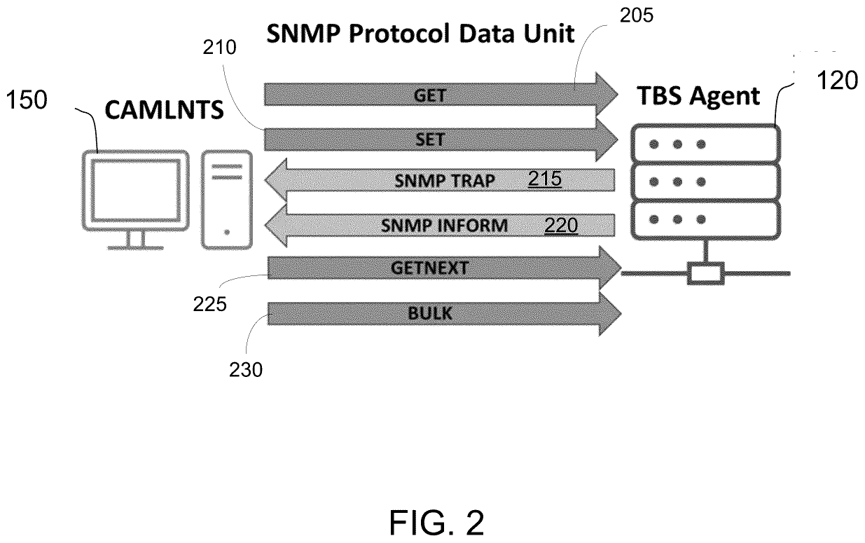

FIG. 2 is an illustration of an exemplary communication process between the CAMLNTS 150 and the TBS 120 using SNMP protocol in which the CAMLNTS acts as the SNMP manager and the TBS acts as the SNMP agent. In a first stage, the CAMLNTS 150 send a GET request 205 to the TBS to retrieve data stored at the TBS including the inventoried variables. The TBS 120 automatically sends the GET Response (not shown) that includes the data requested in the GET request. Following the GET request, the CAMLNTS can also send a SET request 210 to set any variable required for configuring the programs executed on the TBS 120. The TBS 120 responds with a TRAP message 215 to report any events for which the TBS is configurated to trigger notifications. The TBS can also additionally or alternatively send an INFORM message 220 which include notifications of events at the TBS. In the final stages, the CAMLNTS 150 sends a GETNEXT request 225 to find out and obtain additional (e.g., new) information stored at the TBS 120. Last, the CAMLNTS 150 sends a BULK request 230 in order to activate further GETNEXT operations on each variable and to return the data in a single reply.

Returning again to FIG. 1, an AI engine 160 and database 170 are also coupled to the integration hub 145. The AI engine and database 170 receive monitor data and alerts generated by CAMLNTS 140 via the integration hub 145. The received data, which can accumulate into large data sets over time, is stored database 170. The AI engine 160 can include one or more computer processors (e.g., CPUs, GPUs) adapted to execute machine learning algorithms. The AI engine 160 is configured using program code instructions to execute one or more machine learning algorithms that are designed provide early prediction of deficiencies in the network based on the received data including monitored parameters and conditions. As noted above, the parameters and conditions used for training include jamming, temperature, cable connection, and card failure information. For example, during frequency scanning, if the TBS 120 identifies jamming and any source using the TBS reserved frequency, results of this detection are sent to the CAMLNTS 150 as well as the AI Engine 160. The AI Enge 160 automatically correlates the detected interference with existing systems within the affected region of the TBS.

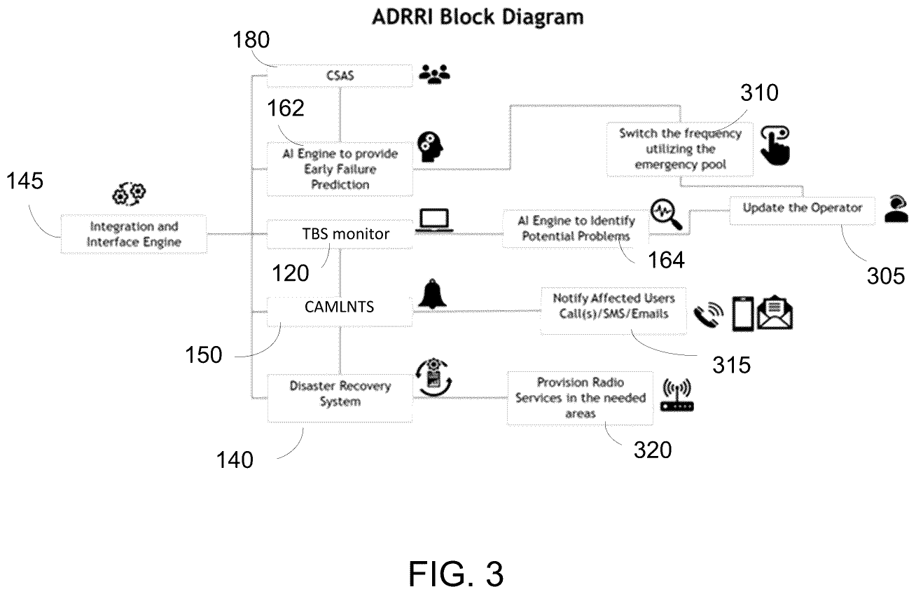

The AI engine 160 is configured to construct a repository of all learned deficiencies which are stored in database 170. In addition, the AI engine 160 is configured to monitor the trends of the specific parameters to check for certain thresholds. For example, a jamming threshold can be set for a certain duration (e.g., 10 minutes, 15 minutes); an internal temperature threshold at the TBS can be set at a certain temperature (e.g., 27 C); and a cable disconnection threshold can be set at a level of dropped transmitted data (e.g., 500-MB-1 GB). Suitable thresholds are also set for card failures indicated by high CPU utilization rates (e.g., >90%). When any of the monitored parameters reach the threshold, early notifications are triggered that a failure is about to or likely to occur. The notifications include details regarding the potential source of failure, in particular which parameter(s) have reached the threshold. The AI engine 160 is also configured to send a dispatching signal for the Disaster Recovery system 140 to be deployed if a failure occurs without autonomous resolution. The AI Engine 160 is also configured to identify historical trends in the monitored data stored in database 170 and to generate recommended resolutions to any problems in the system identified in the historical trends. In some embodiments the AI engine 160 comprises distinct AI modules. An example of this is shown in FIG. 3 which is a schematic diagram that shows functional elements of the ADDRI system and outputs that the system generates to notify affected users or responsible personnel.

As shown in FIG. 3, the integration hub (integration engine) 145 is coupled to a monitoring tool (e.g., part of TBS 120), the recovery team 140, CAMLNTS 150, a predictive AI engine sub-module 162 (which can be a sub-module of AI engine 160), and CSAS 180. Through the integration hub 145, all components can receive and transmit data concerning the of the radio network to each other on a continual or periodic basis. In the schematic illustration, the TBS 120 is configured to transmit data to AI engine sub-module 164 which is configured to diagnose (classify) and determine current problems occurring the system ADDRI system based on the current data received form the TBS monitor. Upon reaching a determination and/or diagnosis, the AI engine sub-module 164 transmits updated information to operators 305, which can take remedial actions. Similarly, when the AI engine sub-module 162 which is configured for early failure prediction determines that a communication failure is likely beyond a certain threshold, it transmits commands the relays 130 to switch the frequency 310 using the emergency pool. As discussed above, the CAMLNTS 150 is configured to transmit notifications concerning communication traffic status to affected users 315 via a range of media depending on the recipient including SMS, email and telephone calls. As also shown in FIG. 3, the disaster recovery team receives instructions to provision radio services 320 in affected areas.

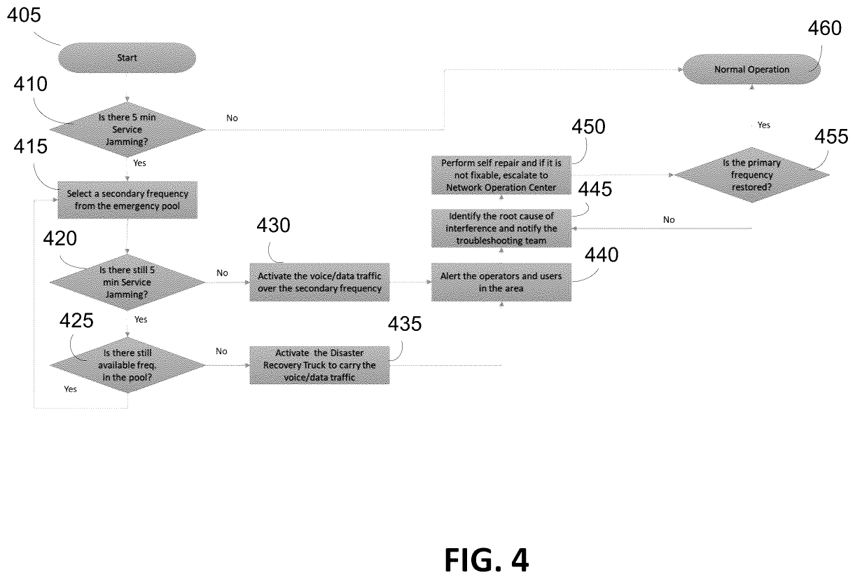

FIG. 4 is a flow chart of a method of switching a frequency of communication service according to an embodiment of the present disclosure. The method begins in step 405. In the following step 410, the TBS determines whether communications services have been jammed on a primary frequency for a set duration (e.g., five minutes). If the determination in step 410 is that communication services have been jammed for the set duration (YES), then the method branches to step 415, in which the TBS transmits signals to select a secondary frequency from the emergency frequency pool. If the determination in step 410 is that communication services have not been jammed for the set duration (NO), normal operation continues, and the method ends in step 460. Following step 415, it is again determined whether communication services have been jammed for the set duration in step 420. If the result of the determination in step 420 is YES, the method branches to step 425 in which it is determined whether any frequency in the emergency pool remain available. Returning to step 420, if the result of the determination is NO, then the method branches to step 430, in which the relays, operating under commands generated by the TBS, activate voice and data traffic on the frequency selected in step 415. Returning to step 425, if the result of the determination in step 425 is YES, then the method cycles back to step 415 and one of the remaining frequencies in the emergency pool is selected. If the result of the determination in step 425 is NO, meaning that there are no frequencies left to switch to, then in step 435, a notification is sent to the recovery team to activate voice and data traffic at the failure site using a mobile radio unit.

After either steps 430 and 435, in step 440, affected users and technical personnel are notified of either the switch to the secondary frequency, or to the activation of the recovery team. In step 445, the AI engine 160 runs a machine learning model to diagnose the cause of the interference and to notify a troubleshooting team after the cause has been determined. In the following step 450, the information regarding the cause of the interference is used as a basis for automated self-repair or, if this is unavailable, the information is escalated to a network operations center to take remedial action. In step 455 it is determined whether the self-repair or other remedial actions have restored operation on the primary frequency. If the result of the determination in step 460 is YES, the method ends in step 460. If the result of the determination in step 455 is NO, then the method cycles back to step 445 for the AI engine to attempt to reidentify the root cause of the interference.

The components of the ADDRI system including the TBS, CAMLNTS, integration hub and AI engine each include one or more electronic processors. The processors can be general purpose central processing units, or in some cases, specialized processors and/or application-specific integrated circuits (ASICs). The systems include memory resources coupled to the processor such as read-only memory (ROM) locally or via a system bus. The components are also coupled to a database (or multiple database) which holds large memory resources for permanent data storage of a large quantity of data. Programmable code is stored in local or system memory at one or more components and can be uploaded/downloaded between the components. The computer readable code can include functional modules, for instance, sections of computer code that, when executed by a processor, cause the steps of workflows to be carried out, and all other process steps described or contemplated in the description.

The TBS, CAMLNTS, integration hub and AI engine, are equipped with a network interface to enable intercommunication between the components of the system. The network interfaces that are coupled to the TETRA network can comprise both wired and wireless communication links.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the invention has been described with reference to exemplary embodiments, it will be understood by those skilled in the art that various changes can be made and equivalents can be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A communication system for automatic detection and resolution of radio interference (ADDRI) comprising:
a wireless communication base station including a transmitter and receiver that are set in a normal operation on a primary frequency, a plurality of sensors adapted to detect current parameters of the base station including a level of interference on a selected primary frequency received by the receiver, and a processor configured to generate a signal based on output of the sensor, and a first relay coupled to the processor;
a set of relays coupled to the first relay of the base station and including a pooling relay, wherein the pooling relay is configured to commence a process of switching the primary frequency to one of a pool of available secondary frequencies upon receipt of a command signal from the based station generated in response to detection by the sensor of interference on the primary frequency;
a centralized monitoring and tracking device coupled to base station and adapted to receive and process the current parameters output by the plurality of sensors in order to determine whether the current parameters are indicative of a defect at the base station, and to send notifications in response to the determination of the defect; and
an AI processor coupled to the centralized monitoring and tracking device and configured to execute a first AI module, the first AI module including executable code for training and executing a first machine learning model that uses, as input, the parameter information received form the centralized monitoring and tracking device, and outputs a classification of a cause of a defect determined by the centralized monitoring and tracking device.

2. The communication system of claim 1, wherein the system communicates using a Terrestrial Trunked radio (TETRA) standard.

3. The communication system of claim 1, further comprising a database coupled to the centralized monitoring and tracking device and the AI processor and adapted to store the current parameters in a repository over time, yielding stored parameter information.

4. The communication system of claim 1, wherein the first machine learning model comprises a recurrent neural network (RNN).

5. The communication system of claim 1, wherein the current parameters output by the plurality of sensors include RF signal jamming time and packet drop rates at the base station.

6. The communication system of claim 5, wherein the current parameters output by the plurality of sensors further include a central processing unit (CPU) utilization rate and an internal temperature of the base station.

7. The communication system of claim 1, wherein the centralized monitoring and tracking device is configured to send a notification to commence remedial actions to restore operation on the primary frequency upon receiving data indicative of interference on the primary frequency at the base station.

8. The communication system of claim 1, further comprising a supervisory alarm system coupled to the centralized monitoring and tracking device, wherein the centralized monitoring and tracking device is configured to determine whether any of the current parameters received has exceeded an operational threshold, and to transmit a signal to the supervisory alarm system detailing any of the current parameters that have exceeded the operational threshold.

9. The communication system of claim 1, wherein the AI processor is configured to execute a second AI module, the second AI module including executable code for training and executing a second machine learning model that uses, as input, interference data on the primary frequency received form the centralized monitoring and tracking device, and outputs a prediction of when operation on the primary frequency is likely to fail.

10. The communication system of claim 1, wherein the set of relays coupled to the relay of the base station includes and including a disaster recovery relay, wherein the disaster recovery relay is configured to alert a disaster recovery team in response to interference on the primary frequency if there are no available secondary frequencies to switch to from the primary frequency.

11. A method for automatic detection and resolution of radio interference (ADDRI) comprising:
detecting, at a sensor of a base station, current parameters of the base station including a level of interference on a selected primary frequency used by the base station during normal operation,
sending a signal in response to interference being detected to commence a process of switching the primary frequency to one of a pool of available secondary frequencies;
determining whether any of the current parameters are indicative of a defect at the base station;
sending a notification in response to a defect being determined;
training a first machine learning model including using the current parameters over time to determine defects in the current parameters;
executing the first machine learning model to output a classification of a cause of the defect in the current parameters of the base station.

12. The method of claim 11, wherein the signal and notification are sent using using a Terrestrial Trunked radio (TETRA) standard.

13. The method of claim 11, further comprising storing the current parameters over time in a repository.

14. The method of of claim 13, further comprising:
training a second machine learning model using the current parameters stored over time in the repository as input; and
executing the machine learning model to output a prediction, based on the input, to output a prediction of when operation on the primary frequency is likely to fail.

15. The method of claim 14, wherein the first and second machine learning models comprise recurrent neural networks (RNNs).

16. The method of claim 11, wherein the current parameters include RF signal jamming time and packet drop rates at the base station.

17. The method of claim 16, wherein the current parameters further include a central processing unit (CPU) utilization rate and an internal temperature of the base station.

18. The method of claim 11, further comprising:
receiving data from the sensor of the base station indicative of interference on the primary frequency; and
sending a notification to commence remedial actions to restore operation on the primary frequency.

19. The method of claim 11, further comprising:
determining whether any of the current parameters has exceeded an operational threshold; and
transmitting a signal to a supervisory alarm system detailing any of the current parameters that have exceeded the operational threshold.

20. The method of claim 1, further comprising:
determining that there there is interference on the primary frequency and that there are no available secondary frequencies to switch to from the primary frequency; and
sending an alert to a disaster recovery.
